(19) United States
(12) Patent Application Publication
(10) Pub. No.: US 2013/0195254 A1
(43) Pub. Date: Aug. 1, 2013

(54) X-RAY CONTROL UNIT USING MONOCRYSTALLINE MATERIAL

(71) Applicants: Sungyoul CHOI, Ulsan (KR); Yoon Ho Song, Daejeon (KR); Jin Woo Jeong, Daejeon (KR); Jun Tae Kang, Daegu (KR); Jae-woo Kim, Daejeon (KR)

(72) Inventors: Sungyoul CHOI, Ulsan (KR); Yoon Ho Song, Daejeon (KR); Jin Woo Jeong, Daejeon (KR); Jun Tae Kang, Daegu (KR); Jae-woo Kim, Daejeon (KR)

(73) Assignee: ELECTRONICS AND TELECOMMUNICATIONS RESEARCH INSTITUTE, Daejeon (KR)

(21) Appl. No.: 13/491,969

(22) Filed: Jun. 8, 2012

(30) Foreign Application Priority Data
Jan. 30, 2012 (KR) 10-2012-0009050

(51) Int. Cl. G21K 3/00

(52) U.S. Cl. 378/156

(57) ABSTRACT

An X-ray control unit using a monocrystalline material which controls only a specific wavelength of X-rays, by using the monocrystalline material as a filter. The X-ray control unit includes a light source configured to generate X-rays, an X-ray control filter formed of a monocrystalline material having grown in one direction and configured to filter the X-rays generated by the light source to reflect and transmit characteristic X-rays, and an adjustor configured to adjust the light source and the X-ray control filter to arbitrary angles. Since X-rays having a specific wavelength can be selectively used by using a filter, the X-rays can be easily controlled and their intensity can be easily regulated. A characteristic line of the X-rays can be controlled and their intensity can be regulated without directly controlling an X-ray source.

### CROSS-REFERENCE TO RELATED APPLICATIONS

This application is based on and claims priority from Korean Patent Application No. 10-2012-0009050, filed on Jan. 30, 2012 with the Korean Intellectual Property Office, the present disclosure of which is incorporated herein in its entirety by reference.

### TECHNICAL FIELD

The present disclosure relates to an X-ray control unit using a monocrystalline material, and more particularly, to an X-ray control unit using a monocrystalline material which controls only a specific wavelength of X-rays radially produced when an electric field is emitted, by using the monocrystalline material as a filter.

### BACKGROUND

A general X-ray tube uses a principle of generating a Bremstralung X-ray generated when electrons collide with a metal anode target with high energy and a characteristic X-ray generated according to an anode target material, and an electronic source generally includes a thermal electronic source and an electronic source using a carbon nano tube. X-rays generated by the above means are generated radially, that is, in all directions.

Such X-rays have high transmittance and thus are used in obtaining a Roentgen image of a human body in the medical field and in a material test in the industrial field, and an intensity of an X-ray needs to be changed according to a photographing objective of the X-ray and a type and a state of a subject.

According to the related art, a tube voltage applied to an X-ray tube, that is, a light source has been adjusted to regulate an intensity of an X-ray, but it is difficult to adjust the tube voltage precisely.

A method of adjusting a light source to regulate an intensity of an X-ray requires a separate X-ray photographing unit depending on the purpose thereof.

### SUMMARY

The present disclosure has been made in an effort to provide an X-ray control unit which can effectively control only a specific wavelength of an X-ray by using a filter formed of a monocrystalline material.

The present disclosure also has been made in an effort to provide an X-ray control unit which can regulate an intensity of an X-ray not by directly controlling the X-ray but by using a filter.

An exemplary embodiment of the present disclosure provides an X-ray control unit including: a light source configured to generate an X-ray; an X-ray control filter formed of a monocrystalline material having grown in one direction and configured to filter the X-ray generated by the light source to reflect and transmit a characteristic X-ray; and an adjustor configured to adjust the light source and the X-ray control filter to arbitrary angles.

The monocrystalline material may be a tetragonal material including aluminum (Al), tungsten (W) and molybdenum (Mo).

A thickness of the X-ray control filter may be determined according to a mass of a growing monocrystalline material. A shape of the X-ray control filter may be determined according to a growth frame, and a size of the monocrystalline filter may be determined according to a temperature of a growing monocrystalline material.

A growth direction of the monocrystalline material may be determined according to reflection and transmission directions of the X-ray.

According to the exemplary embodiments of the present disclosure, an X-ray having a specific wavelength can be selectively used by using a filter, and the X-ray can be easily controlled and an intensity of the X-ray can be easily regulated.

According to the exemplary embodiments of the present disclosure, since a characteristic line of an X-ray can be controlled and an intensity of the X-ray can be regulated without directly controlling an X-ray source, the X-ray can be generated more stably.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating an example of an X-ray photographing unit according to an exemplary embodiment of the present disclosure.

FIG. 2 is a schematic diagram illustrating reflection and transmission of light introduced into a monocrystalline material.

FIG. 3 is a diagram illustrating an X-ray control filter formed of a monocrystalline material according to the exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Hereinafter, an exemplary embodiment of the present disclosure will be described in detail with reference to the accompanying drawings. The configuration, operation, and effects of the present disclosure will be clearly understood through the following detailed description. Prior to the detailed description of the present disclosure, it is noted that the same elements are denoted by the same reference numerals even when represented in different drawings, and a detailed description of known configurations will be omitted when making the essence of the present disclosure obscure.

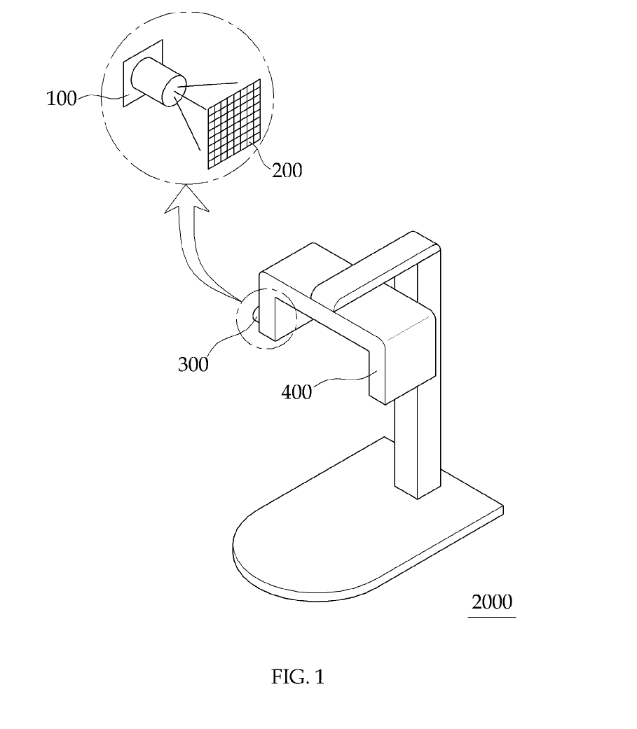

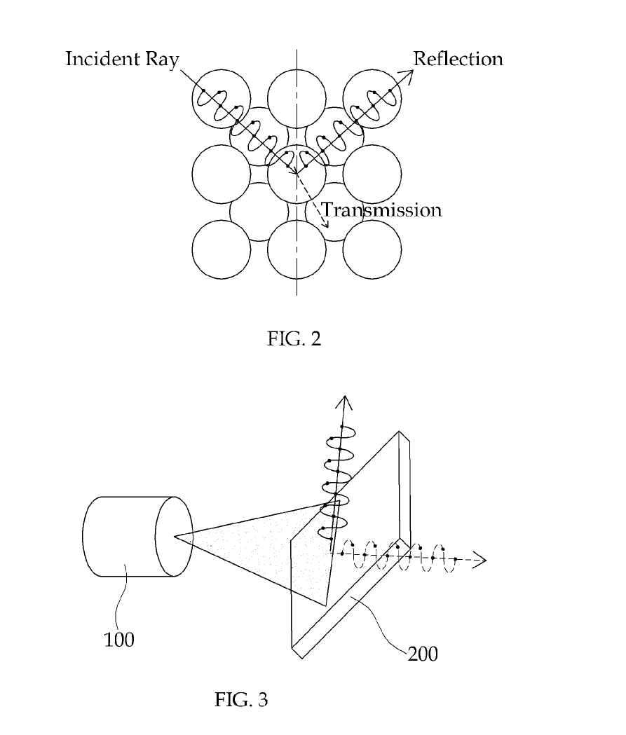

FIG. 1 is a diagram illustrating an example of an X-ray photographing unit according to an exemplary embodiment of the present disclosure.

Referring to FIG. 1, it can be seen that the X-ray photographing unit according to the exemplary embodiment of the present disclosure includes a light source 100 radiating an X-ray, an X-ray control unit 2000 for controlling a direction and an intensity of an X-ray radiated from the light source 100, an adjustor 300 for adjusting the light source and the X-ray control filter to arbitrary angles, and an X-ray detector 400 for receiving an X-ray having passed the subject to acquire an X-ray image of the subject.

The light source 100 serves to generate an X-ray.

The X-ray control unit 2000 includes the adjustor 300 for adjusting the light source 100 and the X-ray control filter to arbitrary angles. The adjustor 300 may freely adjust the angles of the X-ray control filter 200 and the light source 100 themselves to radiate an X-ray in various directions according to a form of a subject and acquire a clear and three-dimensional image and information. The adjustor 300 may be realized by using a simple circuit and a rotary mechanism which are known.

The X-ray control filter 200 is a filter formed of a monocrystalline material, and serves to filter only a characteristic line of an X-ray field emitted from the light source 100 and control an intensity and a direction of the characteristic line.

The X-ray detector 400 serves to detect an X-ray filtered by the X-ray control filter 200 and having passed through a subject.

A monocrystalline material is a material having no impurities and defects, and as illustrated in FIG. 1, reflects and transmits incident energy, that is, an X-ray in specific directions. In this case, the monocrystalline material needs to grow in one direction for a periodic atomic arrangement. The fact that the monocrystalline material grows in one direction means that the atoms thereof are arranged periodically. A material other than a monocrystalline material influences constructive interference and may not control a characteristic line. This is because a defect between crystals or a growth direction forms clusters having different sizes. That is, a multi-wavelength X-ray other than a desired characteristic line is reflected and transmitted.

Thus, in order to maximize an intensity of a wavelength of a ray reflected by a monocrystalline material, a growth direction, an atom size, and an atom arrangement of a monocrystalline material needs to be considered such that a constructive interference can be generated.

The X-ray control filter 200 formed of a monocrystalline material is used, as illustrated in FIG. 3, to reflect and transmit only a characteristic line having a specific wavelength from the X-ray generated by the light source 100.

The monocrystalline material used for the X-ray control filter 200 needs to have one growth direction. Since an atomic arrangement may vary according to a growth direction even in one material, a filter for controlling an X-ray can be manufactured by making growth directions of the material different.

The monocrystalline material is a tetragonal material including aluminum (Al), tungsten (W), and molybdenum (Mo). A tetragonal system structure refers to a crystalline system having two horizontal axes having same lengths orthogonal to each other and vertical axes having different lengths orthogonal to the horizontal axes on the front, rear, left, and right sides. A crystal pertaining to a tetragonal system is optically uniaxial.

A shape, a thickness, and a size of the X-ray control filter 200 are determined such that the X-ray control filter 200 controls a characteristic line having a specific wavelength of an X-ray.

The shape, thickness, and size of the X-ray control filter 200 are determined when the monocrystalline material grows. The growth direction varies according to growth conditions such as a heating temperature, a maintenance temperature, and a cooling temperature of an electric furnace.

For reference, a monocrystalline material grows in a powder form, and the powdery material is heated above a melting point and is gradually cooled to form a monocrystalline structure. Some materials are crystallized around melting points thereof, and some materials are crystallized during cooling processes thereof after being melted. A growth direction of a material is determined according to at which portion the temperature is maintained. The shape of the material may be freely regulated according to the forms of a growth frame for forming a monocrystalline structure and an electric furnace, and the thickness and size of the material are influenced by an amount of powder of the material. Those skilled in the art can form a desired shape of monocrystalline structure by regulating the temperature, the growth frame, the form of the electric furnace, and the amount of powder of the material.

The shape and thickness of the monocrystalline material can be formed by using growth frames such as a concave lens and a convex lens.

In the exemplary embodiment of the present disclosure, an X-ray is used as the light source, but may be used in all field emission light sources. The field emission light sources are next-generation light sources using a phenomenon where electrons are emitted by electric fields, in which case an emitter emitting electrons does not contain mercury and consumes less electric power by applying a nano technology using carbon nano tubes (CNTs) or carbon nano fibers (CNFs).

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An X-ray control unit, comprising:
a light source configured to generate an X-ray;
an X-ray control filter formed of a monocrystalline material having grown in one direction and configured to filter the X-ray generated by the light source to reflect and transmit a characteristic X-ray; and
an adjustor configured to adjust the light source and the X-ray control filter to arbitrary angles

2. The X-ray control unit of claim 1, wherein the monocrystalline material is a tetragonal material including aluminum (Al), tungsten (W) and molybdenum.

3. The X-ray control unit of claim 1, wherein a thickness of the X-ray control filter is determined according to a mass of a growing monocrystalline material, a shape of the X-ray control filter is determined according to a growth frame, and a size of the monicrystalline filter is determined according to a temperature of a growing manocrystalline material.

4. The X-ray control unit of claim 1, wherein a growth direction of the monocrystalline material is determined according to reflection and transmission directions of the X-ray.
